(19) United States
(12) Patent Application Publication
(10) Pub. No.: US 2020/0156409 A1
(43) Pub. Date: May 21, 2020

(54) ADJUSTABLE AIRLESS TIRE SYSTEM WITH SPRING-LOADED SHOCK ABSORBERS

(71) Applicants: Hai Huang, (US); Tony Huang, (US)

(72) Inventors: Hai Huang, Herndon, VA (US); Tony Huang, Herndon, VA (US)

(73) Assignees: Hai Huang, Herndon, VA (US); Tony Huang, Herndon, VA (US)

(21) Appl. No.: 16/752,658

(22) Filed: Jan. 26, 2020

Related U.S. Application Data
(63) Continuation-in-part of application No. 16/137,436, filed on Sep. 20, 2018.
Application No. 16/137,436 is a continuation-in-part of application No. 16/183,681, filed on Nov. 7, 2018.
Application No. 16/183,681 is a continuation-in-part of application No. 16/416,069, filed on May 17, 2019.

(51) Int. Cl. B60C 7/14; B60B 9/02

(52) U.S. Cl. CPC B60C 7/14; B60B 2900/351; B60B 2900/313; B60B 9/02

(57) ABSTRACT

An adjustable airless tire system includes spring-loaded shock absorbers to provide suspension to absorb impact energy and damp spring oscillations; and a metallic hawser loop to transfer the impact energy from the spring-loaded shock absorbers of the ground contact surface of the tire to whole spring-loaded shock absorbers within the tire to maximize their suspension potential. A control component adjusts a tension and a size of the ground contact surface of the tire according to the road conditions, which improve its oil efficiency, comfortability, controllability and safety. An enhanced rim of a wheel keeps an appropriate distance from the tire to protect the spring-loaded shock absorbers and provide limited moving ability for the vehicle if the airless system loses their functions. A curved tire forms a closed space between the tire and the rim to prevent foreign objects from sticking between them.

### FIELD OF THE DISCLOSURE

The present disclosure generally relates to the field of an adjustable airless tire with spring-loaded shock absorber system and, more particularly, relates to using the spring-loaded shock absorbers to support tires, absorb impact energy and damp shock impulses; and a metallic hawser loop controlled under a control component to regulate a tension and a size of the ground contact surface of the tire according road conditions, which possess its advantages of oil efficiency, comfortability, controllability and safety.

### BACKGROUND

Current internal inflated tire uses elasticity of the tire to provide suspension for a vehicle by transferring shock impulses of a rough road from a ground contact surface of a tire to whole walls of the tire through air within the tire. But, the suspension provided by the tire just absorbs and stores impact energy, which will be immediately released and fast rebound the compressed walls of the tire. As a result, it may vibrate the vehicle or even push the tire off the ground, which make the vehicle difficult to handle. Another disadvantage for the internal inflated tire is air leaking if the tire is penetrated by sharp materials.

Nowadays, there are many types of airless tires. But, they just absorb the impact energy from the ground contact surface of the tires, and cannot efficiently transfer the impact energy to whole walls of the tires; they also need special materials that must have enough hardness to support the weight of the vehicle as well as enough elasticity to provide suspension for the vehicle, which have to compromise their functions. As a result, the hardness of the materials limits their suspension potential, and the elasticity of the materials generates greater ground contact surface of the tires, which consumes more oil. In addition, their special materials will also be more expensive.

Road conditions may be different, such as a rough road or slippery one, which need different tension and size of the ground contact surface of the tire to keep comfortability, stability and safety during driving. But, it is not easy for current tires to adjust the tension and size of the ground contact surface of the tire according changes of the road conditions.

The invention designs an adjustable tire system with spring-loaded shock absorbers. Within the system, the springs provide suspension to absorb the impact energy and the shock absorbers damp spring oscillation; a metallic hawser loop transfers the impact energy from the spring-loaded shock absorbers of the ground contact surface of the tire to whole spring-loaded shock absorbers within the tire to maximize their suspension potential to absorb the impact energy; a control component regulates the tension and the size of the ground contact surface of the tire according the road conditions. So, the adjustable airless tire system in the invention improves ride quality and vehicle handling, which possess the advantages of oil efficiency, affordable, comfortability, controllability and safety.

### BRIEF SUMMARY OF THE DISCLOSURE

The present disclosure includes an adjustable airless tire system with spring-loaded shock absorbers. The springs support tires and absorb impact energy, and the shock absorbers damp spring oscillations.

A metallic hawser loop transfers impact energy from the spring-loaded shock absorbers of the ground contact surface of the tire to whole spring loaded shock absorbers within the tires to maximize their suspension potential to absorb the impact energy.

A control component will regulate extension of the metallic hawser loop to regulate a tension and a size of the ground contact surface of the tire according road situations, which improve its fuel economy, comfortability, controllability and safety during driving.

An enhanced rim of a wheel keeps an appropriate distance from the tire to protect the spring-loaded shock absorbers and provide limited moving ability if the airless tire system is failed.

Utilizing any suitable elastomer and all types of reinforcing materials as similar as current internal inflated tires, the adjustable airless tire is economic and affordable. Its curved shape provides a closed space between the tire and the rim to prevent foreign objects from sticking between them.

Other aspects or embodiments of the present disclosure can be understood by those skilled in the art in light of the description, the claims, and the drawings of the present disclosure.

### BRIEF DESCRIPTION OF THE DRAWINGS

The following drawing is merely an example for illustrative purposes according to various disclosed embodiments and is not intended to limit the scope of the present disclosure.

FIG. 1 is a view schematically showing an adjustable airless tire system with spring-loaded shock absorbers related to the present invention.

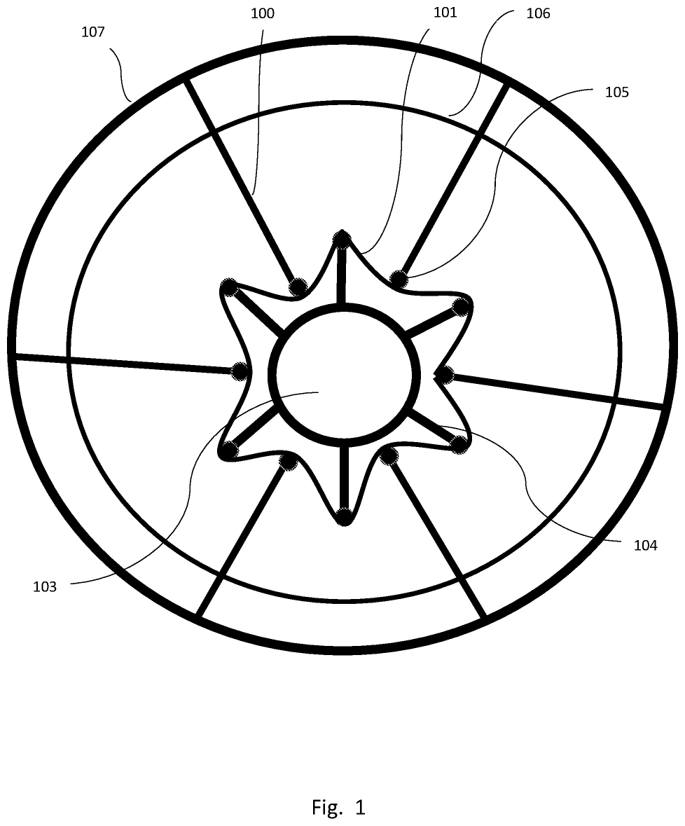

### DETAILED DESCRIPTION

Reference will now be made in detail to exemplary embodiments of the disclosure, which are illustrated in the accompanying drawing. Wherever possible, the same reference numbers will be used throughout the drawing to refer to the same or like parts.

The invention contains appropriate spring-loaded shock absorbers 100 to support a weight of a vehicle, provide suspension to absorb impact energy from a tire 107, and damp spring oscillations to prevent fast rebound of a compressed wall of the tire. A plurality of spoke structure of the spring-loaded shock absorbers radially extend between a metallic hawser loop 101 and inner walls of the tire. One end of the spring-loaded shock absorbers close to the tire is fixed with a shaped plate to fit with the curved inner walls of the tire, and another end of the spring-loaded shock absorbers is fixed with a bearing 105 that contact with the metallic hawse to smooth its movement. The springs within the spring-loaded shock absorbers support the weight of the vehicle, and the spring rates are based on the weight of the vehicle, unloaded and loaded. The springs within the spring-loaded shock absorbers also provide the suspension to absorb the impact energy, which prevent shacking the vehicle. To prevent fast rebound of the compressed wall of the tire due to release the absorbed impact energy from the compressed springs, the shock absorbers within the spring-loaded absorbers serve the purpose of damping spring oscillations and keeping the tire in contact with the ground at all time, which reduce the effect of traveling over rough ground and improve ride quality and vehicle handling.

The invention contains the metallic hawser loop to transfer the impact energy from the spring-loaded shock absorbers of the ground contact surface of the tire to whole spring-loaded shock absorbers within the tire to maximize their suspension potential to absorb the impact energy. The metallic hawser loop pushes the spring-loaded shock absorbers to support whole inner walls of the tire. One function of the metallic hawser is to support the weight of the vehicle coming from the spring-loaded shock absorbers. Another function of the metallic hawser is to transfer the impact energy from the spring loaded shock absorbers of the ground contact surface of the tire to whole spring loaded shock absorbers within the tires. As the ground contact surface of the tire compress the corresponding the spring-loaded shock absorbs, they will compress a corresponding section of the metallic hawser loop inward. The inward metallic hawser loop will tighten other sections of the metallic hawser loop, which push other spring-loaded shock absorbs outward to compress other parts of the walls of the tires. By this way, the impact energy is transferred from the spring-loaded shock absorbers of the ground contact surface of the tire to whole the spring-loaded shock absorbers within the tire through the metallic hawser, which maximize their suspension potential to absorb the impact energy. Parallelly arranging several metallic hawser loops and the spring-loaded shock absorbers will support more parts of the walls of the tire, which will provide more proportionate supports and better suspension to the tire.

The invention contains a control component 103 located at a hub of a wheel to regulate a tension and a size of the ground contact surface of the tire according to road conditions. The control component includes a sensor and control rods. The sensor will detect the tension of the tire to calculate the weight of the vehicle, and will give alert if the tire is overloaded; The sensor also detects a variation of the tension of the tire during driving to judge road condition. An increased variation of the tension of the tire during driving suggest rougher condition of the road. The control rods 104 support the weight of the vehicle coming from the metallic hawser loop. A bearing is fixed at its one end of the control rods to smooth its movement on the metallic hawser loop. The control component can prolong or contract the control rods to regulate extension of the metallic hawser loop, which regulate the tension and size of the ground contact surface of the tire according the road conditions. As a result, it will improve fuel efficiency, comfortability, controllability and safety during driving. First, driving on an even road, regulating the tension of the tire can optimize the size of the ground contact surface of the tire with the road, which will reduce rolling resistance and improve fuel efficiency; second, driving on a rough road, reducing the tension of the tire will increase suspension potential of the springs, which creates a softer ride to improve the comfortability; third, driving on a slippery road, such as raining, icy or snowing, decreasing the tension of the tire will increase the size of the ground contact surface of the tire with the road, which improves the controllability and safety of the vehicle during driving; fourth, driving on sand or mud terrain, increasing the size of the ground contact surface of the tire will decrease pressure of the tire on the ground, which reduces sinking of the tire into sand or mud. It also improves traction of the tire over loose road surface; and fifth, at emergency braking, the increased size of the ground contact surface of the tire will increase frictional resistance between the ground and the tire to decrease braking distance, which may save lives.

The invention contains a rim 106 of the wheel to protect the spring-loaded shock absorbers and provide limited moving ability if the airless tire system is failed. The rim of the wheel is properly enhanced and keeps an appropriate distance from the tire to limit the maximal level of inward movement of the spring-loaded shock absorbers, and support the weight of the vehicle if the tire is overload or the impact energy is too strong. The rim provides limited moving ability if the airless tire system loses their functions. The rim can also help to locate the spring-loaded shock absorbers.

The tire is made of any suitable elastomer with all types of reinforcing materials that is similar as current internal inflated tires to support the weight of the vehicle and enhance its performance. Its cross section of the tire is curved as the internal inflated tires to form a closed space between the tire and the rim with its two sides mounted within the rim flange of the wheel, which prevents foreign objects from sticking between them to improve driving quality and safety.

Other applications, advantages, alternations, modifications, or equivalents to the disclosed embodiments are obvious to those skilled in the art and are intended to be encompassed within the scope of the present disclosure.

What is claimed is:

1. An adjustable airless tire system with spring-loaded shock absorbers comprising:
the spring-loaded shock absorbers supporting a weight of a vehicle, providing suspension to absorb impact energy, and damping spring oscillations to prevent fast rebound of a compressed wall of the tire;
a metallic hawser loop transferring the impact energy from the spring-loaded shock absorbers of the ground contact surface of the tire to whole spring-loaded shock absorbers within the tire to maximize their suspension potential to absorb the impact energy;
a control component regulating a tension and a size of the ground contact surface of the tire according to road conditions;
a rim of a wheel keeping an appropriate distance from the tire to protect the spring-loaded shock absorbers and provide limited moving ability for the vehicle if the airless tire system is failed; and
the tire forming a closed space between the tire and the rim of the wheel to prevent foreign objects from sticking between them.

2. The adjustable airless tire system according to claim 1, further comprising a plurality of spoke structure of the spring-loaded shock absorbers radially extending between the metallic hawser loop and inner walls of the tire, wherein one end of the spring-loaded shock absorbers close to the tire is fixed with a shaped plate to fit with the curved inner walls of the tire and another end of the spring-loaded shock absorbers is fixed with a bearing to contact with the metallic hawser loop.

3. The adjustable airless tire system according to claim 1, wherein the metallic hawser loop pushes the spring-loaded shock absorbers toward the inner walls of the tire.

4. The adjustable airless tire system according to claim 3, wherein parallelly arranging several metallic hawser loops and the spring-loaded shock absorbers will support more sites of the tires to improve their functions.

5. The adjustable airless tire system according to claim 1, wherein the control component further comprises:
a sensor that detects the tension of the tire to calculate the weight of the vehicle and a variation of the tension of the tire during driving to estimate roughness of the road; and
control rods that support the metallic hawser loop and regulate the tension of the tire and the size of the ground contact surface of the tire according to the road conditions by prolonging or contracting the control rods to change the extension of the metallic hawser loop.

6. The adjustable airless tire system according to claim 1, wherein the rim of the wheel keeps an appropriate distance from the tire to limit the maximal level of inward movement of the spring-loaded shock absorbers to protect them and support the weight of the vehicle if the tire is overloaded, and the rim of the wheel is properly enhanced to provide limited moving ability for the vehicle if the adjustable airless tire system lose their functions, and the rim also helps to locate the spring-loaded shock absorbers.

7. The adjustable airless tire system according to claim 1, wherein the tire is made of suitable elastomer with all types of reinforcing materials, and the cross section of the tire is curved with its two sides of the tire mounted within the rim flange of the wheel to make a closed space between the tire and the rim to prevent foreign objects from sticking between them.
